(19) United States
(12) Patent Application Publication
(10) Pub. No.: US 2021/0271979 A1
(43) Pub. Date: Sep. 2, 2021

(54) METHOD, A SYSTEM, A STORAGE PORTION AND A VEHICLE ADAPTING AN INITIAL MODEL OF A NEURAL NETWORK

(71) Applicants: TOYOTA JIDOSHA KABUSHIKI KAISHA, Toyota-shi (JP); INSTITUT NATIONAL DE RECHERCHE EN INFORMATIQUE ET EN AUTOMATIQUE (INRIA), Le Chesnay Cedex (FR)

(72) Inventors: Gabriel OTHMEZOURI, Lxelles (BE); Ozgur ERKENT, Grenoble (FR); Christian LAUGIER, Grenoble (FR)

(21) Appl. No.: 17/184,815

(22) Filed: Feb. 25, 2021

(30) Foreign Application Priority Data
Feb. 28, 2020 (EP) 20305205.5

(51) Int. Cl. G06N 3/08; G06N 3/04; G06K 9/62

(52) U.S. Cl. CPC G06N 3/088; G06N 3/0454; G06K 9/6256; G06K 9/6261; G06K 9/6215

(57) ABSTRACT

This method adapts an initial model trained with labeled images of a source domain into an adapted model. It comprises:
copying the initial model into the adapted model;
dividing the adapted model into an encoder part and a second part, wherein the second part is configured to process features output from said encoder part;
adapting said adapted model to a target domain using images (xₛ) of the source and target domains while fixing the parameters of said second part and minimizing a function of following two distances:
   a distance between features of the source domain output of the encoders of the initial model and of the adapted model; and
   a distance measuring a distribution distance between probabilities of features obtained for images of the source domain and of the target domain.

### CROSS-REFERENCE TO RELATED APPLICATION

This application claims priority to European Patent Application No. 20305205.5 filed on Feb. 28, 2020, incorporated herein by reference in its entirety.

### BACKGROUND

### 1. Technical Field

The present disclosure relates to the field of image processing and more precisely to the improvement of classification performance of neural networks.

### 2. Description of the Related Art

The disclosure finds a privileged application in the field of images classification for autonomous driving vehicles, but may be applied to process images of any type.

Semantic information provides a valuable source for scene understanding around autonomous vehicles in order to plan their actions and make decisions.

Semantic segmentation of those scenes allows recognizing cars, pedestrians, traffic lanes, etc. Therefore, semantic segmentation is the backbone technique for autonomous driving systems or other automated systems.

Semantic image segmentation typically uses models such as neural networks to perform the segmentation. These models need to be trained.

Training a model typically comprises inputting known images to the model. For these images, a predetermined semantic segmentation is already known (an operator may have prepared the predetermined semantic segmentations of each image by labelling the images). The output of the model is then evaluated in view of the predetermined semantic segmentation, and the parameters of the model are adjusted if the output of the model differs from the predetermined semantic segmentation of an image.

In order to train a semantic segmentation model, a large number of images and predetermined semantic segmentations are necessary.

For example, it has been observed that the visual condition in bad weather (in particular when there is fog blocking the line of sight) creates visibility problems for drivers and for automated systems. While sensors and computer vision algorithms are constantly getting better, the improvements are usually benchmarked with images taken during good and bright weather. Those methods often fail to work well in other weather conditions. This prevents the automated systems from actually being used: it is not conceivable for a vehicle to avoid varying weather conditions, and the vehicle has to be able to distinguish different objects during those conditions.

It is thus desirable to train semantic segmentation models with varying weather images (images taken during multiple state of visibility due to weather conditions).

However, obtaining semantic segmentation data during those varying weather conditions is particularly difficult and time-consuming.

The disclosure proposes a method that may be used for adapting a model trained for images acquired in good weather conditions to other weather conditions.

### SUMMARY

More particularly, according to a first aspect, the disclosure proposes a method of adapting an initial mode of a neural network into an adapted model, wherein the initial model has been trained with labeled images of a source domain, said method comprising:
copying the initial model into the adapted model;
dividing the adapted model into an encoder part and a second part, wherein the second part is configured to process features output from the encoder part;
adapting the adapted model to a target domain using random images of the source domain and random images of the target domain while fixing parameters of the second part and adapting parameters of the encoder part.

The adapted model minimizes a function of two following distances:
a first distance D1 measuring a distance between features of the source domain output of the encoder part of the initial model and features of the source domain output of the encoder part of the adapted model; and
a second distance D2 measuring a distribution distance between probabilities of these features obtained for images of the source domain and probabilities of these features obtained for images of the target domain.

The adapted model may be used for processing new images of the source domain or of the target domain.

In a particular embodiment of the disclosure, the adapted model may be used for classifying, or segmenting the new images. The adapted model may also be used for creating bounding boxes enclosing pixels of the new images. The adapted model may also be used to identify a predetermined object in the new images. The adapted model may also be used to compute a measure of the new images, eg a light intensity.

From a very general point of view, the disclosure proposes a method of adapting a model trained for images of a source domain to images of a target domain.

In one application of the disclosure, images of the source domain are images acquired in high visibility conditions and images of the target domain are images acquired in low visibility conditions.

Also, the expressions “low visibility conditions” and “high visibility conditions” merely indicate that the visibility (for example according to a criterion set by the person skilled in the art) is better under the “high visibility conditions” than under the “low visibility conditions, the gap between the two visibility conditions can be chosen by the person skilled in the art according to the application.

According to the disclosure the adapted model is based on a trained model which has been trained for images of the source domain.

This trained model provides good accuracy for the images of the source domain but not for images of the target domain.

According to the disclosure, the adapted model is obtained by adapting weights of an encoder part of the trained model, the architecture of the trained model and the weights of the second part of the trained model being unchanged. This results in a shorter adaptation training time by considerably reducing the complexity of the adaptation while preserving a good accuracy for images of the source domain.

The cut of the initial trained model into an encoder part and a second part can be made at any layer of the initial model.

Selecting this layer may be achieved after trial-and-error, for example using images of the source domain. The man skilled in the art may select this layer while taking into account that:
this layer must be deep enough so that the features output of the encoder vary enough;
this layer be deep enough to have enough features to calculate the relevant distributions probabilities of D2;
this layer should not be too deep, to avoid too high complexity for calculating D1 and D2.

The disclosure provides two distances D1 and D2.

D1 measures the distance between features of the source domain output of the encoder part of the initial model and features of the source domain output of the encoder part of the adapted model. This measure represents how the accuracy of the processing of images of the source domain degrades.

D2 measures a distribution distance between probabilities of features obtained for images of the source domain and probabilities of features obtained for images of the target domain. For D2 to be relevant, images of the target domain must statistically represent the same scenes as the images of the source domain but the disclosure does not require a correspondence among images of these two domains. D2 then represents the capacity of the adapted model to process images of the source domain and images of the target domain with the same accuracy.

Function f being based on D1 and D2, the disclosure provides an adapted model which is optimized such that the probability distributions are similar for source and target domains features while keeping the accuracy of the processing of images of the source domain close to the one achieved with the trained initial model.

The adapted model is therefore adapted to process new images of the source domain or of the target domain, in other words images acquired whatever the visibility conditions.

According to a particular embodiment, the function is in the form of (μD2+λD1), where μ and λ are positive real numbers and D1 is the first distance and D2 is the second distance.

These parameters μ and λ may be used to balance the weights of distances D1 or D2.

Other functions f based on D1 and D2 may be used. Preferably the function must be increasing of D1 and increasing of D2.

According to a particular embodiment, the step of adapting the parameters of the encoder part uses a self-supervision loss to measure the first distance D1.

Therefore, in this embodiment, unlabeled images are used for adapting the trained model to the adapted model, labelled-images being used only for training the initial model. This embodiment avoids the need for annotating images or obtaining semantic segmentation data in the target domain, for example for varying visibility conditions.

Measuring D2, the distribution distance between probabilities of features obtained for images of the source domain and probabilities of features obtained for images of the target domain, is complex.

In one embodiment, this distance is obtained statistically using a maximum mean discrepancy metric.

According to another embodiment, the second distance D2 is obtained by a second neural network used to train adversarially said encoder part to adapt the parameters of the adapted model.

The second neural network is therefore trained to learn how to measure D2.

In this embodiment, the second neural network may be for example a 1st order Wasserstein neural network or a Jensen-Shannon neural network.

For more information about adversarially training, the man skilled in the art may in particular refer to:

T.-H. Vu, H. Jain, M. Bucher, M. Cord, and P. Perez: “ADVENT: Adversarial Entropy Minimization for Domain Adaptation in Semantic Segmentation,” in CVPR, 2019): or

Y. Luo, L. Zheng, T. Guan, J. Yu, and Y. Yang, “Taking A Closer Look at Domain Shift: Category-level Adversaries for Semantics Consistent Domain Adaptation,” in CVPR, 2019, pp. 2507-2516).

According to a second aspect, the disclosure concerns a system for adapting an initial model of a neural network into an adapted model wherein the initial model has been trained with labeled images of a source domain, said system comprising:
a preparing module configured to copy the initial model into the adapted model and to divide the adapted model into an encoder part and a second part, wherein the second part is configured to process features output from the encoder part; and
an adapting module configured to adapt said adapted model to a target domain using random images of the source domain and random images of the target domain while fixing the parameters of said second part and adapting the parameters of said encoder part, said adapted model minimizing a function of the two following distances: —a first distance measuring a distance between features of the source domain output of the encoder part of the initial model and features of the source domain output of the encoder part of the adapted model; and
a second distance measuring a distribution distance between probabilities of these features obtained for images of the source domain and probabilities of these features obtained for images of the target domain,

said adapted model being used for processing new images of said source domain or of said target domain.

In one embodiment of the disclosure, the system is a computer comprising a processor configured to execute the instructions of a computer program.

According to a third aspect, the disclosure related to a computer program comprising instructions to execute a method of adapting an initial model as mentioned above.

The disclosure also relate to storage portion comprising:
an initial model of a neural network which has been trained with labelled images of a source domain; and
an adapted model obtained by adaptation of said initial model using an adaptation method as mentioned above,

wherein the initial model and the adapted model both have an encoder part and a second part configured to process features output from their respective encoder part, the second part of the initial model and the second part of the adapted model having the same parameters.

The disclosure also concerns a vehicle comprising an image acquisition module configured to acquire images, storage portion comprising an adapted model as mentioned above and a module configured to process the acquired images using the adapted model.

### BRIEF DESCRIPTION OF THE DRAWINGS

How the present disclosure may be put into effect will now be described by way of example with reference to the appended drawings, in which:

FIG. 1 shows a flow chart of a method of adapting an initial model of a neural network according to one embodiment of the disclosure.

FIG. 2 represents an example of the training of an initial model.

FIG. 3 gives examples of images that can be used in the disclosure.

FIG. 4 represents the architectures of the initial model and of the adapted model.

FIG. 5 represents the architectures of the initial model and of the adapted model.

FIG. 6 represents an encoder part and a second part of the initial model of FIG. 2 during the training.

FIG. 7 represents an encoder part and a second part of the target model during adaptation.

FIG. 8 represents an adaptation step that may be used in a specific embodiment of the disclosure.

FIG. 9 represents a system for adapting an initial model of a neural network according to one embodiment of the disclosure.

FIG. 10 represents the architecture of the system of FIG. 9 according to one embodiment of the disclosure.

FIG. 11 represents a vehicle according to one embodiment of the disclosure.

### DETAILED DESCRIPTION OF EMBODIMENTS

Reference will now be made in detail to exemplary embodiments of the disclosure, examples of which are illustrated in the accompanying drawings. Wherever possible, the same reference numbers will be used throughout the drawings to refer to the same or like parts.

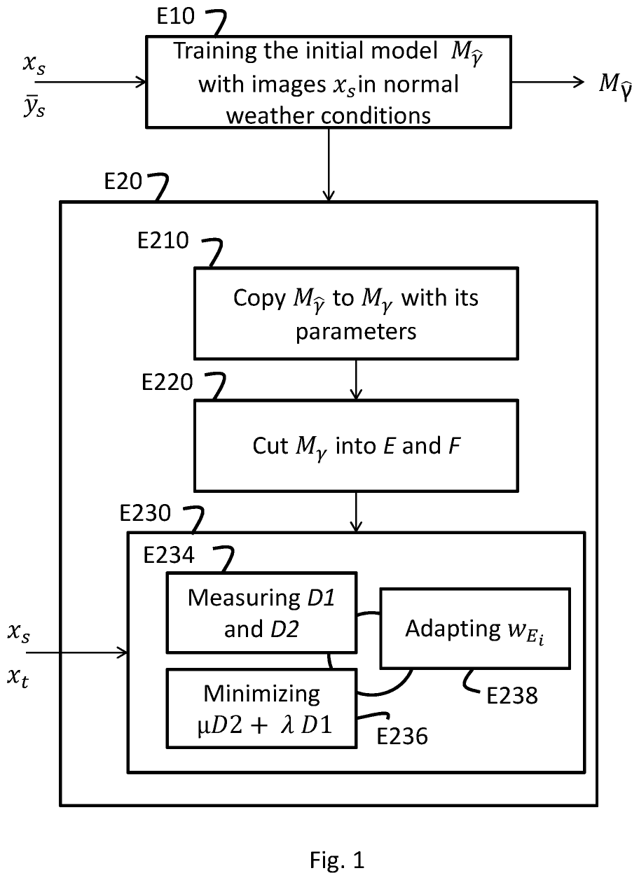

FIG. 1 shows a flow chart of a method of adapting an initial model M_{\hat{γ}} of a neural network according to one embodiment of the disclosure.

The disclosure has been implemented with Segnet, MobileNeyV2 and DeepLabV3 but others architectures may be used.

More precisely, the method of the disclosure adapts the initial model M_{\hat{γ}} trained with source domain images xₛ obtained in high visibility conditions to images of a target domain xₜ obtained in low visibility conditions (eg dark, foggy or snowy conditions).

At step E10, the initial model M_{\hat{γ}} is trained with source domain images xₛ obtained in high visibility conditions.

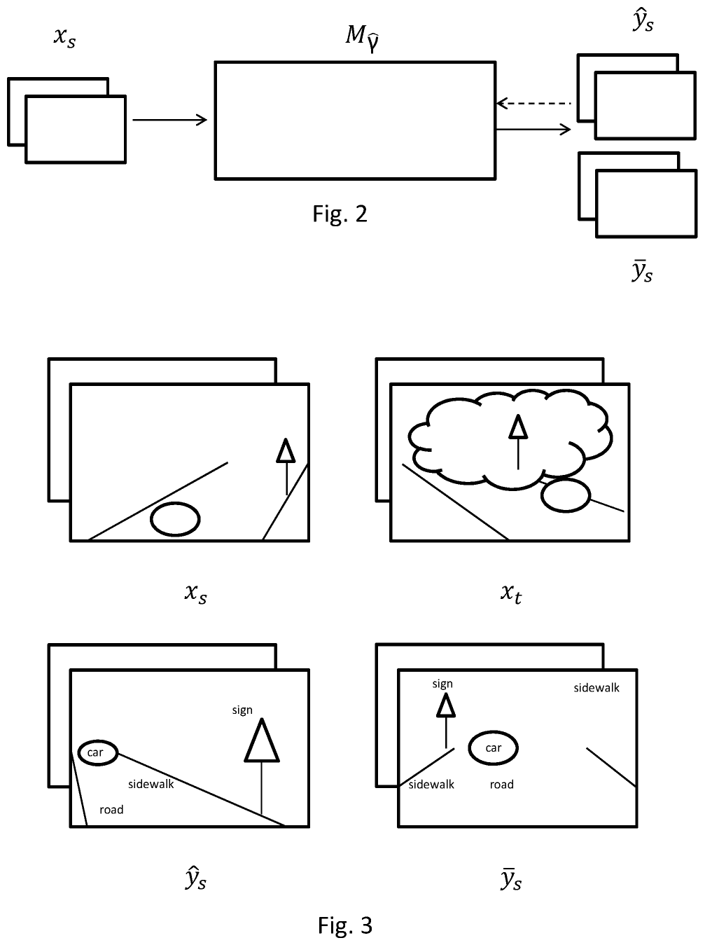

As shown on FIGS. 2 and 3, labeled images ŷₛ are obtained. This training step E10 uses ground truth images y̅ₛ for the source domain. On FIG. 2 and subsequent figures, the dotted arrow represents the back-propagation.

FIG. 3 represents examples of images xₛ of the source domain, with their corresponding labeled images of ground truth y̅ₛ and ŷₛ labeled images output by the initial model M_{\hat{γ}}. The specific example of FIG. 3 represents an image xₛ represented a scene obtained in high visibility conditions, the labeled image ŷₛ in which a sign, a sidewalk, a car and a road have been detected and an image xₜ of the target domain, ie an image of the same scene obtained in low visibility conditions.

FIG. 4 is a representation of the architecture of the initial model M_{\hat{γ}}. In this example, 5 layers are represented: the input layer L₁, the output layer L₅, and three hidden layers L₂, L₃, L₄. The parameters (or weights) of the initial model M_{\hat{γ}} are noted W₁, W₂, W₃, W₄.

In an adaptation step E20, the initial model M_{\hat{γ}} is adapted to the target domain. The adapted model is noted M_{γ}. This adaptation step E20 comprises two preparing steps of copying E210, and dividing E220 the initial model to initialize the adapted model and an adaptation step per se E230 of the adapted model.

The initial model M_{\hat{γ}} is copied to the adapted model M_{γ} with its parameters during the copying step E210.

Then, at step E220, the adapted model M_{γ} is divided into two parts: an encoder part E and a second part F. This division can be made at any layer of the initial model M_{\hat{γ}} the output layer of the encoder part E being the input layer of the classification part F.

Selecting this layer may be achieved after trial-and-error, for example using images of the source domain. The man skilled in the art may select this layer while taking into account that:
this layer must be deep enough so that the features output of the encoder vary enough;
this layer be deep enough to have enough features to calculate the relevant distributions probabilities of D2;
this layer should not be too deep, to avoid too high complexity for calculating D1 and D2.

From experience, a good accuracy may be achieved when the cut is made between the 2^{nd} and the 6^{th} layers for networks of size in between 10 and 15 layers.

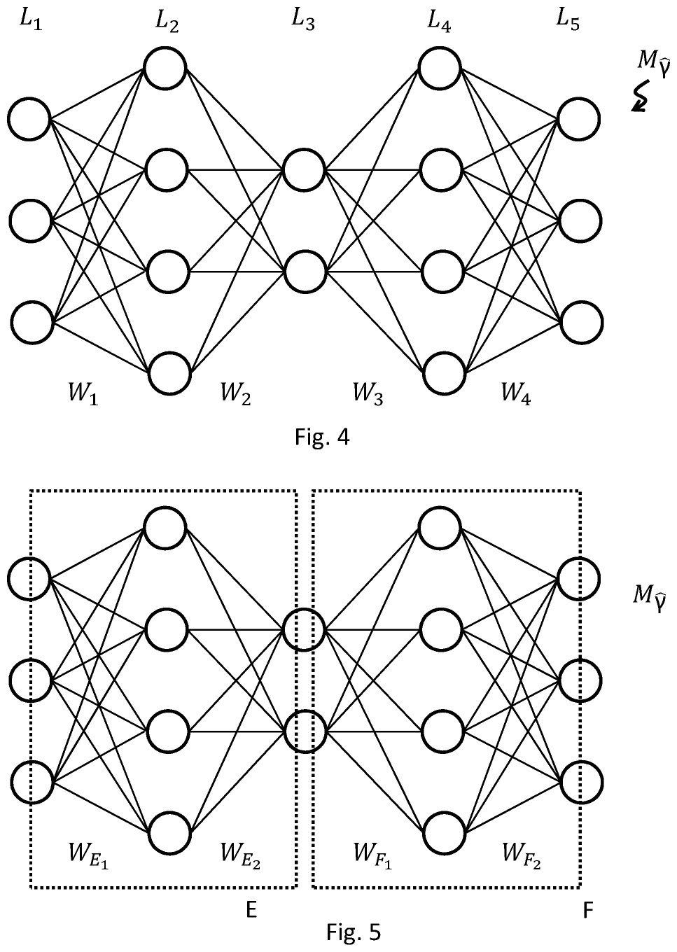

FIG. 5 represents the architecture of the adapted model M_{γ} after the dividing step E220 assuming that the cut was made on layer L₃ of the initial model M_{\hat{γ}}. If we respectively note W_{E}_{ᵢ} the weights of the encoder part E and W_{F}_{ᵢ} the weights of the second part F, then after step E220: W_{E}_{₁}=W₁; W_{E}_{₂}=W₂; W_{F}_{₁}=W₃ and W_{F}_{₂}=W₄.

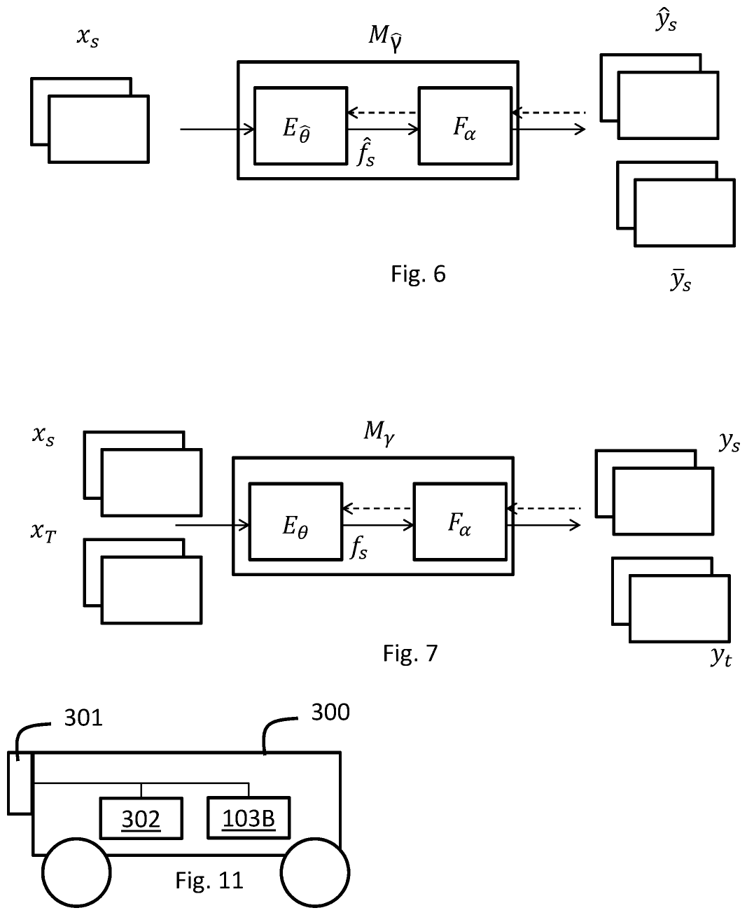

FIG. 6 is similar to FIG. 2. In FIG. 6, we note \hat{θ} the set of parameters of the encoder part E of the initial model M_{\hat{γ}}, \hat{f}ₛ the set of features from the source domain xₛ output of the encoder part E of the initial model M_{\hat{γ}} and α the set of parameters of the second part F.

During the adaptation step E230, the adapted model M_{γ} is adapted to the target domain by using random images xₛ of the source domain and random images xₜ of the target domain. No correspondence exists between these images.

According to the disclosure, the adapted model M_{γ} has the same architecture as the initial model M_{\hat{γ}}, only the weights W_{E}_{ᵢ} of the encoder part E being adapted.

As represented on FIG. 7, we note:
yₛ the segmentation of images of the source domain;
yₜ the segmentation of images of the target domain with the adapted model M_{γ};
θ the set of parameters of the encoder part E of the adapted model M_{γ}; and
fₛ the set of features from the source domain xₛ output of the encoder part E of the adapted model M_{γ}.

The set α of parameters of the second part F is unchanged.

According to the disclosure, the adaption comprises minimizing a function f of distances D1 and D2 detailed below.

In this specific embodiment, f is in the form of (μD2+λD1), where λ and μ are real positive numbers.

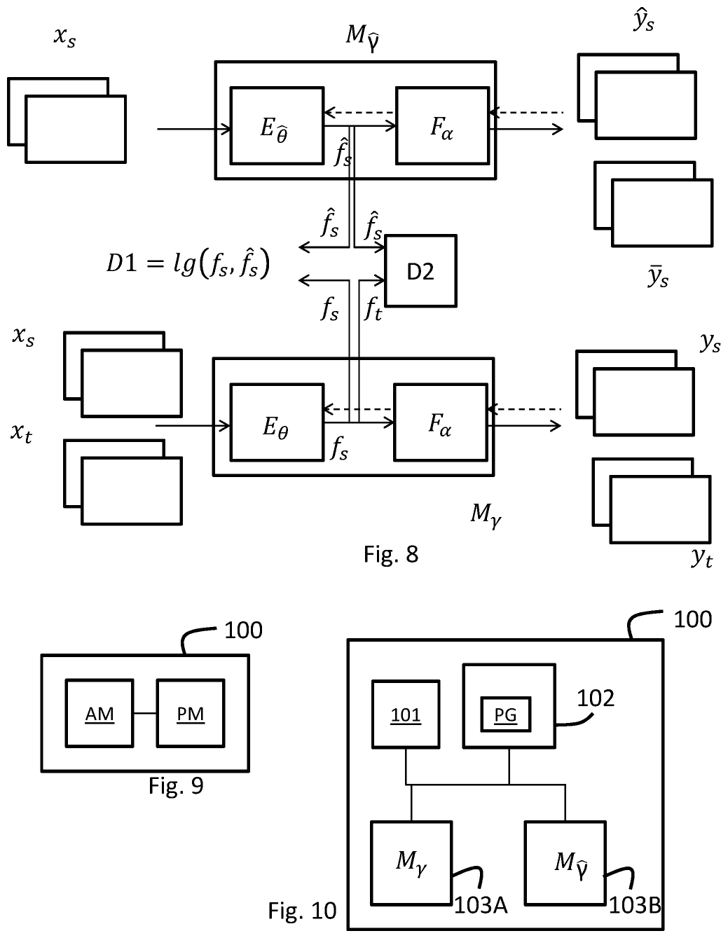

The adaptation step E230 is represented by FIG. 8.

The adaptation step E230 comprises a step E234 of measuring:
a first distance D1 between (i) the features \hat{f}ₛ of the source domain xₛ output of the encoder part E of the initial model M_{\hat{γ}} and (ii) the features fₛ of the source domain xₛ output of the encoder part E of the adapted model M_{γ}; and
a second distance D2 between (i) the probabilities Pr_{(\hat{f}}_{ₛ}_{)˜p} of features obtained for images xₛ of the source domain and (ii) the probabilities Pr_{(E}_{_{θ}}₍ₓ_{ₜ}_{))˜q} of features obtained for images xₜ of the target domain.

The adapted model M_{γ} is optimized (by adapting the weights of the encoder part at step E238) such that the probabilities distributions Prₚ and Pr_{q} are similar for source and target domain features (measured by difference D2) and the accuracy of the source domain does not degrade (measured by D1, F being unchanged).

In this specific embodiment, the step E238 of adapting the parameters W_{E}_{ᵢ} of said encoder part E uses a self-supervision loss to measure the first distance D1.

In this specific embodiment, this optimization consists in minimizing, f=(μD2+λD1) (step E236) where μ and λ are real parameters that can be adjusted to balance D1 and D2.

In one embodiment, at step E234, the second distance D2 can be obtained statistically using a maximum mean discrepancy MMD metric.

But in the specific embodiment described here, the second distance D2 is obtained by a second neural network used to train adversarially the said encoder part E to adapt (E238) its parameters W_{E}_{ᵢ}.

FIG. 9 represents a system 100 for adapting an initial model of a neural network according to one embodiment of the disclosure.

This system comprises a preparing module PM and an adapting module AM.

The preparing module is configured to obtain an initial model M_{\hat{γ}} which has been trained with labeled images xₛ, y̅ₛ of a source domain, to copy this initial model into an adapted model M_{γ} and to divide the adapted model into an encoder part E and a second part F.

The adapting module AM is configured to adapt the adapted model M_{γ} to a target domain xₜ using random images xₛ of the source domain and random images xₜ of the target domain as mentioned before.

FIG. 10 represents the architecture of the system of FIG. 9 according to one embodiment of the disclosure.

In this specific embodiment, the system 100 is a computer. It comprises a processor 101, a read only memory 102, and two flash memories 103A, 103B.

The read only memory 102 comprises a computer program PG comprising instructions to execute a method of adapting an initial model as mentioned above when it is executed by the processor 101.

In this specific embodiment, flash memory 103A comprises the initial model M_{\hat{γ}} and flash memory 103 B comprises the adapted model M_{γ}.

Flash memories 103A and 103 B constitute a storage portion according to an embodiment of the disclosure.

In another embodiment, the initial model M_{\hat{γ}} and the adapted model M_{γ} are stored in different zones of a same flash memory. Such a flash memory constitutes a storage portion according to another embodiment of the disclosure.

FIG. 11 represents a vehicle 300 comprising an image acquisition module 301 and a system 302 comprising a model trained by the method as described above to perform semantic segmentation on the images acquired by the image acquisition module.

FIG. 11 represents a vehicle 300 according to one embodiment of the disclosure. It comprises an image acquisition module 301 configured to acquire images, storage portion 103B comprising an adapted model M_{γ} as mentioned above and a module 302 configured to classify the images acquired by the module 301 using the adapted model.

In the specific embodiment described before, the second part F is a classifier.

The claims method adapts (at step E20) an initial model M_{\hat{γ}} of a neural network into an adapted model M_{γ}, the initial model M_{\hat{γ}} having been trained (at step E10) with labeled images of a source domain.

In this specific embodiments, these labeled images are images xₛ of the source domain, with their corresponding labeled images of ground truth y̅ₛ.

The method comprises:
copying (at step E210) the initial model M_{\hat{γ}} into the adapted model M_{γ};
dividing (at step E220) the adapted model M_{γ} into an encoder part E and a classification part F configured to process features \hat{f}ₛ output from the encoder part E.

The adapted model M_{γ} is adapted to a target domain xₜ using random images xₛ of the source domain and random images xₜ of the target domain while fixing the parameters W_{F}_{ᵢ} of the classification part and adapting (at step E238) the parameters W_{E}_{ᵢ} of the encoder part E, the adapted model M_{γ} minimizing the f function the two distances D1 and D2.

The adapted model M_{γ} may be used to classify new images of the source domain or of said target domain.

What is claimed is:

1. A method of adapting an initial model of a neural network into an adapted model, wherein the initial model has been trained with labeled images of a source domain, said method comprising:
copying the initial model into the adapted model;
dividing the adapted model into an encoder part and a second part, wherein the second part is configured to process features output from said encoder part;
adapting said adapted model to a target domain using random images of the source domain and random images of the target domain while fixing parameters of said second part and adapting parameters of said encoder part, said adapted model minimizing a function of following two distances:
a first distance measuring a distance between features of the source domain output of the encoder part of the initial model and features of the source domain output of the encoder part of the adapted model; and
a second distance measuring a distribution distance between probabilities of said features obtained for images of the source domain and probabilities of said features obtained for images of the target domain,
said adapted model being used for processing new images of said source domain or of said target domain.

2. The method of claim 1, wherein said function is in the form of (μD2+λD1), where μ and λ are positive real numbers and D1 is the first distance and D2 is the second distance.

3. The method of claim 1, wherein adapting the parameters of said encoder part uses a self-supervision loss to measure said first distance.

4. The method of claim 1, wherein said second distance is obtained by a second neural network used to train adversarially said encoder part to adapt said parameters of said adapted model.

5. The method of claim 4, wherein said second neural network is a 1^{st} order Wasserstein neural network or a Jensen-Shannon neural network.

6. The method of claim 1, wherein said second distance is obtained statistically using a maximum mean discrepancy metric.

7. A system for adapting an initial model of a neural network into an adapted model, wherein the initial model has been trained with labeled images of a source domain, said system comprising:
a preparing module configured to copy the initial model into the adapted model and to divide the adapted model into an encoder part and a second part, wherein the second part is configured to process features output from said encoder part; and
an adapting module configured to adapt said adapted model to a target domain using random images of the source domain and random images of the target domain while fixing the parameters of said second part and adapting the parameters of said encoder part, said adapted model minimizing a function of following two distances:
a first distance measuring a distance between features of the source domain output of the encoder part of the initial model and features of the source domain output of the encoder part of the adapted model; and
a second distance measuring a distribution distance between probabilities of said features obtained for images of the source domain and probabilities of said features obtained for images of the target domain,
said adapted model being used for processing new images of said source domain or of said target domain.

8. Storage portion comprising:
an initial model of a neural network which has been trained with labeled images of a source domain; and
an adapted model obtained by adaptation of said initial model using an adaptation method according to claim 1,
wherein the initial model and the adapted model both have an encoder part and a second part configured to process features output from said encoder part, the second part of the initial model and the second part of the adapted model having the same parameters,
said adapted model being used to classify new images of said source domain or of said target domain.

9. A vehicle comprising:
an image acquisition module configured to acquire images
a storage portion according to claim 8 comprising an adapted model; and
a module configured to process said acquired images using said adapted model.
